(19) United States
(12) Patent Application Publication
(10) Pub. No.: US 2026/0064184 A1
(43) Pub. Date: Mar. 5, 2026

(54) SAFETY ENHANCEMENT AND ENABLING OF ADVANCED LOWER POWER STATES IN AN ELECTRONIC DEVICE OF A VEHICLE

(71) Applicant: QUALCOMM Incorporated, San Diego, CA (US)

(72) Inventors: Jae Gon LEE, Mountain View, CA (US); Robin GARG, Panchkula (IN); Xiuting Cheng MAN, Austin, TX (US); Nitin MAKHIJA, San Jose, CA (US)

(21) Appl. No.: 18/821,904

(22) Filed: Aug. 30, 2024

(51) Int. Cl. G06F 1/3287; G06F 1/3237; B60R 16/023; B60R 16/03

(52) U.S. Cl. CPC G06F 1/3287; G06F 1/3237; B60R 16/023; B60R 16/03

(57) ABSTRACT

Certain aspects of the present disclosure provide a method at a monitoring device. The method may include determining whether power is completely turned off to processing elements from a power source during a power saving state and/or whether the power is completely turned on to the processing elements from the power source during a normal power state, based on monitoring of a power controller configured to turn or off the power to the processing elements from the power source. The method may further include transmitting an alert signal when the power is not completely turned off to processing elements from the power source during the power saving state and/or the power is not completely turned on to the processing elements from the power source during the normal power state.

### BACKGROUND

### Field of the Disclosure

Certain aspects of the present disclosure generally relate to electronic components, and more particularly to safety monitoring and power management of an integrated circuit (IC) chip in a vehicle.

### Description of the Related Art

Over the past several years, a vehicle has been transformed from a self-propelled mechanical vehicle into a powerful and complex electro-mechanical system that includes a large number of sensors and processors that control many of the vehicle’s functions, features, and operations. The vehicle may be equipped with a vehicle control system, which may be configured to collect and use information from the vehicle’s various systems and sensors to automate all or a portion of the vehicle’s operations. For example, an advanced driver assistance system (ADAS) may automate, adapt, or enhance the vehicle’s operations. The ADAS may use information collected from the sensors (e.g., accelerometer, radar, lidar, geospatial positioning, etc.) to automatically detect a potential road hazard, and assume control over all or a portion of the vehicle’s operations (e.g., braking, steering, etc.) to avoid detected hazards. Features and functions commonly associated with an ADAS include adaptive cruise control, automated lane detection, lane departure warning, automated steering, automated braking, and automated collision avoidance. The vehicle monitors for errors associated with the control system, and the vehicle may notify an operator of such errors, shut down certain systems, or operate in a degraded state in response to detecting certain errors.

### SUMMARY

The systems, methods, and devices of the disclosure each have several aspects, no single one of which is solely responsible for its desirable attributes. Without limiting the scope of this disclosure as expressed by the claims which follow, some features will now be discussed briefly. After considering this discussion, and particularly after reading the section entitled “Detailed Description,” one will understand how the features of this disclosure provide the advantages described herein.

Certain aspects of the present disclosure provide an apparatus, which may include a power controller configured to turn off power to one or more processing elements from a power source during a power saving state and turn on power to the one or more processing elements from the power source during a normal power state; and a monitoring device configured to: determine at least one of whether the power is completely turned off to the one or more processing elements from the power source during the power saving state or whether the power is completely turned on to the one or more processing elements from the power source during the normal power state based on monitoring of the power controller, and transmit an alert signal when at least one of the power is not completely turned off to the one or more processing elements from the power source during the power saving state or the power is not completely turned on to the one or more processing elements from the power source during the normal power state.

Certain aspects of the present disclosure provide an apparatus, which may include a power controller configured to turn on or turn off power to one or more processing elements from a power source, and a timer configured to calculate an amount of time being taken by the power controller to turn on or turn off the power to the one or more processing elements from the power source and transmit an alert signal when the calculated time exceeds a threshold.

Certain aspects of the present disclosure provide an apparatus, which may include a clock controller configured to enable or disable one or more clock signals to one or more processing elements, and a timer configured to calculate an amount of time being taken by the clock controller to enable or disable the one or more clock signals to the one or more processing elements and transmit an alert signal when the calculated time exceeds a threshold.

Certain aspects of the present disclosure provide a method at a monitoring device. The method may include determining at least one of: whether power is completely turned off to one or more processing elements from a power source during a power saving state or whether the power is completely turned on to the one or more processing elements from the power source during a normal power state, based on monitoring of a power controller configured to turn off the power to the one or more processing elements from the power source during the power saving state and turn on the power to the one or more processing elements from the power source during the normal power state. The method may further include transmitting an alert signal when at least one of: the power is not completely turned off to the one or more processing elements from the power source during the power saving state or the power is not completely turned on to the one or more processing elements from the power source during the normal power state.

Certain aspects of the present disclosure provide a method at a timer. The method may include calculating an amount of time being taken by a power controller to turn on or turn off power to one or more processing elements from a power source. The method may further include transmitting an alert signal when the calculated time exceeds a threshold.

Certain aspects of the present disclosure provide a method at a timer. The method may include calculating an amount of time being taken by a clock controller to enable or disable one or more clock signals to one or more processing elements. The method may further include transmitting an alert signal when the calculated time exceeds a threshold.

Other aspects provide: an apparatus operable, configured, or otherwise adapted to perform the aforementioned methods as well as those described elsewhere herein; a non-transitory, computer-readable media comprising instructions that, when executed by one or more processors of an apparatus, cause the apparatus to perform the aforementioned methods as well as those described elsewhere herein; a computer program product embodied on a computer-readable storage medium comprising code for performing the aforementioned methods as well as those described elsewhere herein; and an apparatus comprising means for performing the aforementioned methods as well as those described elsewhere herein. By way of example, an apparatus may comprise a processing system, a device with a processing system, or processing systems cooperating over one or more networks.

To the accomplishment of the foregoing and related ends, the one or more aspects comprise the features hereinafter fully described and particularly pointed out in the claims. The following description and the appended drawings set forth in detail certain illustrative features of the one or more aspects. These features are indicative, however, of but a few of the various ways in which the principles of various aspects may be employed.

### BRIEF DESCRIPTION OF THE DRAWINGS

So that the manner in which the above-recited features of the present disclosure can be understood in detail, a more particular description, briefly summarized above, may be by reference to aspects, some of which are illustrated in the appended drawings. It is to be noted, however, that the appended drawings illustrate only certain aspects of this disclosure and are therefore not to be considered limiting of its scope, for the description may admit to other equally effective aspects.

FIG. 1 is a diagram of an example vehicle with a vehicle control system, in which aspects of the present disclosure may be practiced.

FIG. 2 is a block diagram of example components and interconnections in a system-on-a-chip (SoC), in which aspects of the present disclosure may be practiced.

FIG. 3 is a block diagram of an example SoC-based electronic control unit (ECU) in communication with one or more other ECUs, in which aspects of the present disclosure may be practiced.

FIG. 4 is a block diagram of an example safety monitoring system that may include at least a monitoring device configured for monitoring signals during a power saving state and a normal power state of one or more processing elements, in accordance with certain aspects of the present disclosure.

FIG. 5 is a flow diagram depicting example operations performed at a monitoring device for monitoring signals during a power saving state and a normal power state of one or more processing elements, in accordance with certain aspects of the present disclosure.

FIG. 6 is a block diagram of an example safety monitoring system that may include at least a timer configured for monitoring operations of a power controller and a clock controller, in accordance with certain aspects of the present disclosure.

FIG. 7 is a flow diagram depicting example operations performed at a timer for determining an amount of time being taken by a power controller to turn on or turn off power to one or more processing elements from a power source, in accordance with certain aspects of the present disclosure.

FIG. 8 is a flow diagram depicting example operations performed at a timer for determining an amount of time being taken by a clock controller to enable or disable one or more clock signals to one or more processing elements, in accordance with certain aspects of the present disclosure.

To facilitate understanding, identical reference numerals have been used, where possible, to designate identical elements that are common to the figures. It is contemplated that elements disclosed in one aspect may be beneficially utilized on other aspects without specific recitation.

### DETAILED DESCRIPTION

Aspects of the present disclosure relate to safety monitoring and power management of electronic circuits, such as those utilized in a vehicle (e.g., an electric vehicle).

Power gating is a technique that cuts off power supply from a power source to an electronic circuit (e.g., the electronic circuit may be electrically coupled to a voltage supply provided by the power source) that is not in use (e.g., when the electronic circuit may not need to be powered up to save overall power consumption). Power gating reduces/minimize both leakage power and dynamic power of the electronic circuit. For example, the electronic circuit that is not in use may be temporarily turned off to reduce the power consumption. This temporary shutdown time may be called as a low power mode or an inactive mode of the electronic circuit (e.g., a low power state / power saving state). When the electronic circuit may be required for operation once again, the electronic circuit is activated to an active mode (e.g., a normal power state). In some aspects, there may be more steps it may take for the electronic circuit to exit a power gating state, as the electronic circuit may require voltage rails ramped, clock relocked, and many other steps involved. The power gating technique may provide the most power reduction at a cost of potentially taking longer to resume back the electronic circuit to the active mode.

Clock gating is a power management technique used in the electronic circuit for reducing dynamic power dissipation, by removing a clock signal when the electronic circuit, or a subpart of the electronic circuit, is not in use or ignores the clock signal. The electronic circuit may remain powered during clock gating with states maintained. This may allow the electronic circuit an ability to resume to the active mode in much shorter time than a power gated condition. In this case, the power saving may not be as optimal as the electronic circuit may still be powered and consumes leakage power, but the clock gating has an advantage of a lower latency for the electronic circuit to resume back to the active state for better performance. For example, the clock gating may save power by selectively disabling clock signals to unused circuitry of the electronic circuit.

In some vehicles, only clock gating may be enabled for certain circuits. This may limit an ability of the vehicle to take advantage of a wide range of idle conditions to reduce the power consumption of the electronic circuits of the vehicle (e.g., which may be achieved by enabling other power consumption methods as well other than the clock gating) and may only allow for a limited lower power state of the electronic circuit of the vehicle.

To allow for an extended lower power state of the electronic circuit of the vehicle, the clock gating as well as the power gating may be enabled. The extended lower power state of the electronic circuit of the vehicle may enable users of the vehicle better flexibility to reduce the power consumption at low and idle conditions of the vehicle, which in turn may enable the vehicle longer use time before a next charge of the vehicle is required. The flexibility of dynamically changing from the active mode of the electronic circuit to the clock gating to power gating conditions may enable optimized performance, latency and power consumption reduction at the electronic circuit.

In order to allow or enable the extended lower power state of the electronic circuit of the vehicle, safety monitoring of the electronic circuit of the vehicle has to be enhanced (e.g., to ensure a smooth transition between different power states). For example, techniques proposed herein may enhance the safety monitoring of the electronic circuit of the vehicle during all power states and during the transition between the different power states by using watchdog timer mechanisms and safety monitor logic.

In one aspect, a watchdog timer may be used to track an expected low power state transition of the electronic circuit of the vehicle versus an actual execution of the low power state transition of the electronic circuit of the vehicle. The watchdog timer may generate alerts (e.g., when there is a difference between the expected low power state transition of the electronic circuit of the vehicle and the actual execution of the low power state transition) that may enable an error and safety detection logic to take actions. In another aspect, a power gating safety monitoring device may monitor states of different signals (e.g., clock signals, power switch control signals against expectations) to enable a power gating switch control logic to work properly and send alerts as needed based on the monitoring (e.g., when a change or changes from expected power gating signals/conditions of the electronic circuit of the vehicle is detected).

The techniques proposed herein may enable the users of the vehicle to use the expanded and extended lower power states for the electronic circuit of the vehicle while not compromising safety requirements of the vehicle. As noted above, the extended lower power state may enable the users of the vehicle better flexibility to reduce the power consumption during low power and idle conditions of the vehicle. This flexibility may, in turn, enable the vehicle longer use time before the next charge is required.

### Example Vehicle Control System

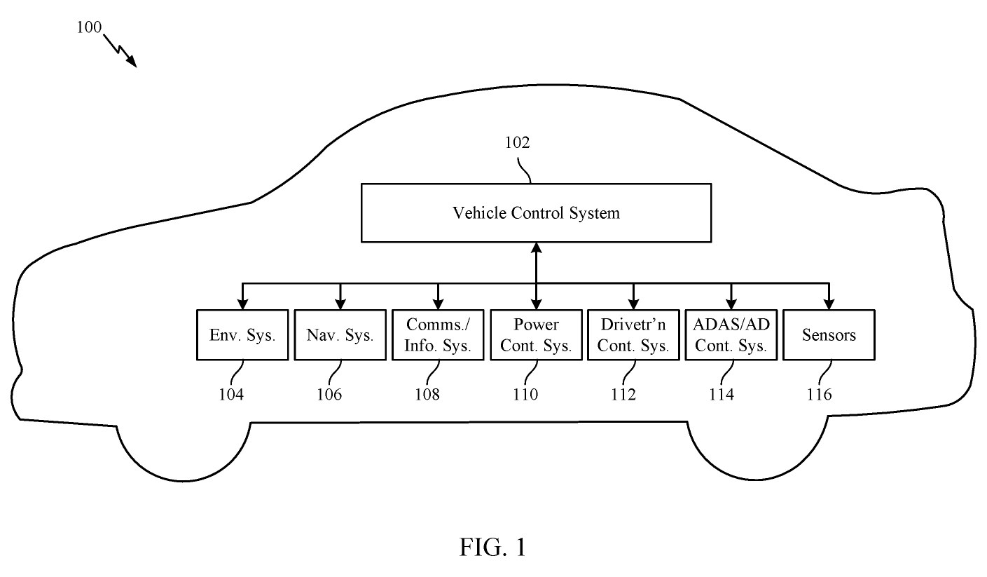

FIG. 1 is a block diagram of an example vehicle 100 including a vehicle control system 102 and various sensors suitable for controlling certain systems, such as an advanced driver assistance system (ADAS), automated driving (AD), and/or in-vehicle infotainment (IVI). The vehicle 100 may refer to a means of carrying or transporting something (e.g., a person and/or cargo). In some aspects, the vehicle 100 may represent a motor vehicle, such as a car, van, truck, semi-trailer truck, motorcycle, motorbike, moped, electric bicycle, etc. The vehicle 100 may be a series production road vehicle having safety-related systems that include one or more electrical and/or electronic systems, as further described herein. The vehicle 100 may use an internal combustion engine, an electric motor, or a hybrid propulsion system (e.g., a combination of an engine and an electric motor) for propulsion. In some cases, the vehicle 100 may have one or more electrical and/or electronic systems that comply with certain functional safety standards, such as ISO 26262 as provided by the International Organization for Standardization (ISO).

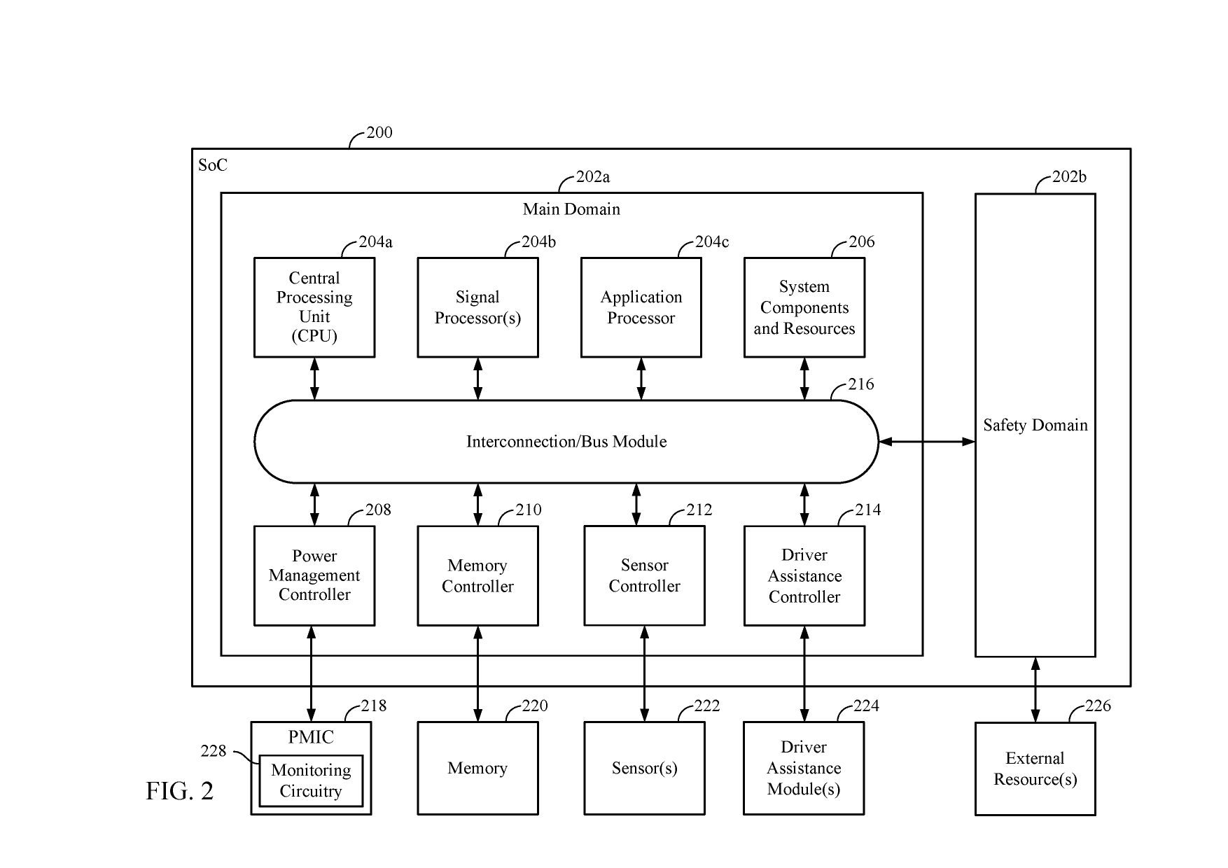

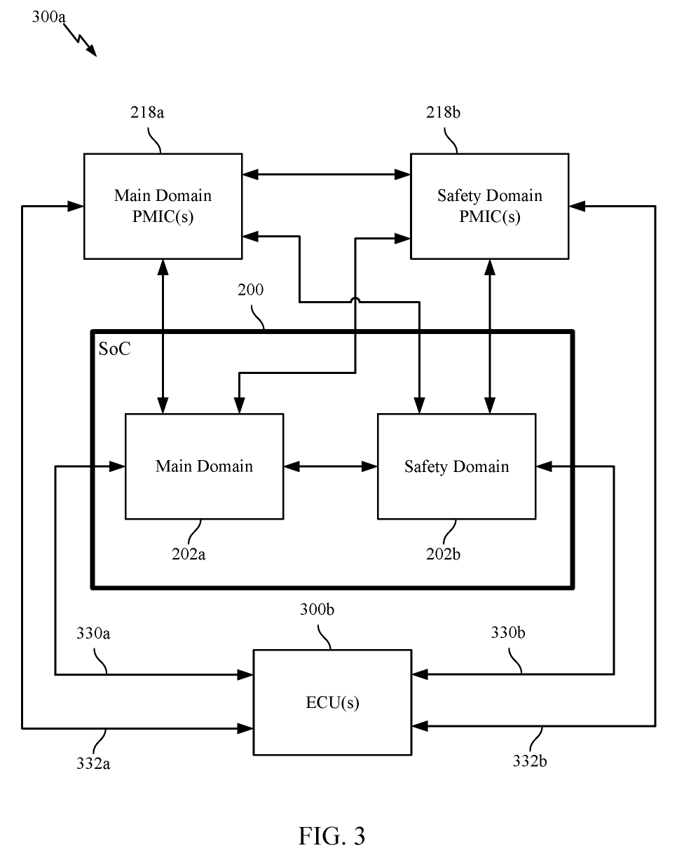

The vehicle 100 may include a vehicle control system 102, which may include one or more computing devices having system-on-a-chips (SoCs) (e.g., one or more electronic control units (ECUs)) as further described herein with respect to FIGS. 2 and 3. The vehicle control system 102 may be coupled to a variety of vehicle systems and subsystems, such as an environmental system 104 (e.g., an air conditioning and/or heating system), a navigation system 106, a communications and/or infotainment system 108, a power control system 110, a drivetrain control system 112, a driver assistance and/or automated driving control system 114, and/or a variety of sensors 116. Each vehicle system or subsystem may communicate with one or more other systems (and/or subsystem(s)) via one or more communication links, which may include wired communication links (e.g., a Controller Area Network (CAN) protocol compliant bus, Universal Serial Bus (USB) connection, Ethernet connection, universal asynchronous receiver-transmitter (UART), etc.) and/or wireless communication links (e.g., a Wi-Fi® link, Bluetooth® link, ZigBee® link, ANT+® link, etc.).

The vehicle control system 102 may perform certain operations associated with any of the vehicle systems and subsystems. For example, the vehicle control system 102 may control or initiate the power-on and/or shutdown sequence for any of the vehicle systems and subsystems. The vehicle control system 102 may monitor for errors associated with any of the vehicle systems and subsystems, and in some cases, the vehicle control system 102 may store the errors for vehicle diagnostics. In response to any errors detected, the vehicle control system 102 may perform certain actions, such as shutting down the affected system or transferring some of the affected operations to be performed at a different vehicle system. The vehicle control system 102 may monitor the power levels supplied to any of the vehicle systems and subsystems and ensure that the power levels supplied satisfy the operating specifications for any of the vehicle systems and subsystems.

The environmental system 104 may control the cooling and/or heating systems associated with the vehicle 100. For example, the vehicle 100 may have an air conditioning system, a heating system, heated or cooled seat(s), and/or a heated steering wheel, and the environmental system 104 may adjust the temperature according to user (or default) settings for the respective cooling and/or heating components. The navigation system 106 may show the vehicle’s location on a map and provide navigation information, such as directions to a destination, via a display and/or a speaker (neither shown).

The communications and/or infotainment system 108 may allow the user to access various information (e.g., navigation information, interior or exterior environmental information, ADAS information, etc.), applications, and/or entertainment or media content, such as music and/or videos. The communications and/or infotainment system 108 may allow the user to update or access settings associated with a variety of systems, such as the environmental system 104, the navigation system 106, ADAS, vehicle settings, etc. The communications and/or infotainment system 108 may allow the user and/or vehicle 100 to wirelessly communicate via an integrated modem of the vehicle or via the user’s wireless communication device (e.g., a smartphone or tablet).

The power control system 110 may control the components that output power to move the vehicle, such as an internal combustion engine (e.g., adjusting the air-fuel ratio, boost pressure, valve timing, etc.), an electric power system (e.g., controlling regenerative braking, battery power output, battery charging, battery cooling, etc.), and/or a hybrid power system (e.g., controlling regenerative braking, switching between battery power and engine power, battery charging, battery cooling, etc.). The drivetrain control system 112 may control the various components of the vehicle 100 that deliver power to the drive wheels. For example, the drivetrain control system 112 may control gear shifting in an automatic transmission. For a four-wheel drive vehicle, the drivetrain control system 112 may control the power ratio applied to the front and rear drive wheels.

The driver assistance and/or automated driving control system 114 may control various driver assistance features and functions, such as adaptive cruise control, automated lane detection, lane departure warning, automated steering, automated braking, and automated collision avoidance. The driver assistance and/or automated driving control system 114 may control automated driving at various levels of automation, such as any of the Society of Automotive Engineers (SAE) levels 1 through 5.

The variety of sensors 116 coupled to the vehicle control system 102 may include a speedometer, a wheel speed sensor, a torquemeter, a turbine speed sensor, a variable reluctance sensor, a sonar system, a radar system, an air-fuel ratio meter, a water-in-fuel sensor, an oxygen sensor, a crankshaft position sensor, a curb feeler, a temperature sensor, a Hall effect sensor, a manifold absolute pressure sensor, various fluid sensors (e.g., engine coolant sensor, transmission fluid sensor, etc.), a tire-pressure monitoring sensor, a mass airflow sensor, a speed sensor, a blind spot monitoring sensor, a parking sensor, cameras, microphones, accelerometers, compasses, a global navigation satellite system (GNSS) receiver (e.g., a global positioning system (GPS) receiver or a Galileo receiver), and other similar sensors for monitoring physical or environmental conditions in and around the vehicle.

The aforementioned systems are presented merely as examples, and vehicles may include one or more additional systems that are not illustrated for clarity. Additional systems may include systems related to additional other functions of the vehicular system, including instrumentation, airbags, cruise control, other engine systems, stability control parking systems, tire pressure monitoring, antilock braking, active suspension, battery level and/or management, and a variety of other systems.

### Example System-On-A-Chip

The term “system-on-a-chip” (SoC) is used herein to refer to a single integrated circuit (IC) chip that contains multiple resources and/or processors (or processing elements) integrated on a single substrate or in a single package. A single SoC may contain circuitry for digital, analog, mixed-signal, and radio-frequency functions. A single SoC may also include any number of general purpose and/or specialized processors (digital signal processors, modem processors, video processors, etc.), memory blocks (e.g., ROM, RAM, flash, etc.), and resources (e.g., timers, voltage regulators, oscillators, etc.). A SoC may also include software for controlling the integrated resources and processors, as well as for controlling peripheral devices.

FIG. 2 is a block diagram of example components and interconnections in a SoC 200 suitable for implementing various aspects of the present disclosure. The SoC 200 may include multiple processing domains having, for example, at least one main domain 202a and at least one safety domain 202b (also referred to as a “safety island (SAIL)”). In the case of multiple main (or safety) domains, the main (or safety) domains may be similar to one another. For ease of description and illustration, the remainder of the disclosure may refer to a main domain 202a and a safety domain 202b, but the reader is to understand that there may be more than one main domain and/or more than one safety domain.

The main domain 202a may be configured to support (or be capable of performing) vehicle operations (e.g., driver assistance and/or automated driving operations, features, etc.) up to a specific automotive safety integrity level (ASIL), and the safety domain 202b may be configured to support (or be capable of performing) vehicle operations up to a lower, the same, or a higher ASIL than the main domain 202a. For example, the main domain 202a may be configured to support (or be capable of performing) vehicle operations up to an ASIL B, and the safety domain 202b may be configured to support vehicle operations up to an ASIL D. In some cases, the main domain 202a may be configured to support (or be capable of performing) vehicle operations up to an ASIL A, B, C, or D, and the safety domain 202b may be configured to support vehicle operations up to a different ASIL than the main domain 202a. In certain cases, the main domain 202a and the safety domain 202b may be configured to support (or be capable of performing) vehicle operations at the same ASIL (e.g., ASIL D). The main domain 202a and the safety domain 202b may be configured to support (or be capable of performing) vehicle operations at different ASILs.

The ASILs may be defined in a specific safety standard, such as ISO 26262. For example, the ASILs may provide a risk classification scheme for certain electrical and electronic systems of road vehicles. ISO 26262 provides four ASILs including ASIL A, ASIL B, ASIL C, and ASIL D. ASIL D is the highest classification and corresponds to the highest level of safety measures for avoiding an unreasonable residual risk, and ASIL A is the lowest classification and corresponds to the lowest level of safety measures.

In certain aspects, the SoC 200 may be included in a computing device (e.g., an ECU) in a vehicle control system. The SoC 200 may control any of the systems described herein with respect FIG. 1. For example, the SoC 200 may be configured to control an ADAS/AD system, such as the driver assistance and/or automated driving control system 114 described herein with respect to FIG. 1. In certain aspects, the SoC 200 may be in communication with other ECU(s) in a vehicle control system, and the SoC 200 and/or a PMIC 218 may report errors associated with the SoC 200 to the other ECU(s), as further described herein with respect to FIG. 3. For example, the main domain 202a may control the environmental system, the infotainment system, and driver assistance features up to a certain ASIL, and the safety domain 202b may control driver assistance features up to a certain ASIL, which may typically be higher than the main domain 202a.

The main domain 202a and/or safety domain 202b may include a number of heterogeneous processors 204a-c (collectively referred to herein as “processors 204”), such as a central processing unit (CPU) 204a, signal processor(s) 204b (e.g., a digital signal processor, an image signal processor, a neural network signal processor, etc.), and/or an application processor 204c. Each processor 204 may include one or more cores, and each processor/core may perform operations independent of the other processors/cores. Each processor 204 may be part of a subsystem (not shown) including one or more processors, caches, etc. configured to handle certain types of tasks or computations. It should be noted that the main domain 202a and/or safety domain 202b may include additional processors (not shown) or may include fewer processors (not shown). The main domain 202a and/or safety domain 202b may include other processors (e.g., a graphics processing unit (GPU), a vision processing unit, etc.) in addition to or instead of those illustrated.

The main domain 202a and/or safety domain 202b may include system components and resources 206 for performing certain specialized operations, such as analog-to-digital conversions and/or wireless data transmissions. The system components and resources 206 may include components such as voltage regulators, oscillators, phase-locked loops (PLLs), modems, peripheral bridges, data controllers, system controllers, access ports, timers, and other similar components used to support the processors and software clients running on the SoC 200. The system components and resources 206 may include circuitry for interfacing with peripheral devices, such as cameras, electronic displays, wireless communication devices, external memory chips, etc.

The main domain 202a and/or safety domain 202b may further include a power management controller 208, a memory controller 210 (e.g., a dynamic random access memory (DRAM) memory controller and/or a non-volatile memory controller), a sensor controller 212, and/or a driver assistance controller 214. The main domain 202a and/or safety domain 202b may also include an input/output (IO) module (not shown) for communicating with resources external to the SoC, such as a clock and a voltage regulator, each of which may be shared by two or more of the internal SoC components. The IO module may include a general purpose IO (GPIO) interface, for example. In certain aspects, each of the main domain 202a and the safety domain 202b may have a separate clock and power supply to facilitate independent operability.

The processors 204 of the main domain 202a may be interconnected to the system components and resources 206, the power management controller 208, the memory controller 210, the sensor controller 212, the driver assistance controller 214, other system components, and/or the safety domain 202b via an interconnection/bus module 216, which may include an array of reconfigurable logic gates and/or implement a bus architecture (e.g., CoreConnect, advanced microcontroller bus architecture (AMBA), etc.). Communications may be provided by advanced interconnects, such as high performance networks-on-chip (NoCs).

The interconnection/bus module 216 may include or provide a bus mastering system configured to grant SoC components (e.g., processors, peripherals, etc.) exclusive control of the bus (e.g., to transfer data) for a set duration, number of operations, number of bytes, etc. In certain aspects, the interconnection/bus module 216 may include a direct memory access (DMA) controller (not shown) that enables components connected to the interconnection/bus module 216 to operate as a master component and initiate memory transactions. The interconnection/bus module 216 may implement an arbitration scheme to prevent multiple master components from attempting to drive the bus simultaneously.

The power management controller 208 may manage the power supplied to the main domain 202a from a PMIC 218, which may be representative of one or more PMIC(s). In some cases, the power management controller 208 may report errors associated with the main domain 202a and/or safety domain 202b to the PMIC 218, as further described herein. The power management and error monitoring control may be separate and independent between the main domain 202a and the safety domain 202b.

The memory controller 210 may be a specialized hardware module configured to manage the flow of data to and from a memory 220. The memory controller 210 may include logic for interfacing with the memory 220, such as selecting a row and column in a cell array of the memory 220 corresponding to a memory location, reading or writing data to the memory location, etc. The memory 220 may be an on-chip component (e.g., on the substrate, die, integrated chip, etc.) of the SoC 200, or alternatively (as shown) an off-chip component.

The sensor controller 212 may manage the sensor data received from various sensors 222, such as the sensors 116. The sensor controller 212 may include circuitry for interfacing with the sensors 222. For example, the sensor controller 212 may receive sensor data from a tire pressure monitoring system and/or a radar sensor used for adaptive cruise control.

The driver assistance controller 214 may control certain driver assistance functions via a driver assistance module 224 (e.g., one or more actuators, relays, switches, etc.). For example, the driver assistance controller 214 may control the adaptive cruise control by controlling actuators coupled to the engine and/or braking system. In some cases, the driver assistance controller 214 may perform automated steering by controlling actuators attached to the steering system. It will be appreciated that the driver assistance controller 214 is merely an example, and the main domain 202a and/or the safety domain 202b may include a controller that interfaces with automated driving components in addition to or instead of the driver assistance controller 214.

The SoC 200 may also include additional hardware and/or software components that are suitable for collecting sensor data from sensors, including speakers, user interface elements (e.g., input buttons, touch screen display, etc.), microphone arrays, sensors for monitoring physical conditions (e.g., location, direction, motion, orientation, vibration, pressure, temperature, etc.), cameras, compasses, GPS receivers, communications circuitry (e.g., Bluetooth®, wireless local area network (WLAN), Long Term Evolution (LTE), Fifth Generation New Radio (5G NR), etc.), and other well-known components (e.g., accelerometer, etc.) of modern electronic devices.

Each of the processing domains may operate independently of the other domains. In some cases, each of the processing domains may be coupled to separate and independent external resources, such as a PMIC, memory, sensor(s), and driver assistance module(s). A particular external resource may be designed in accordance with an ASIL corresponding to the particular ASIL associated with the main domain 202a and/or the safety domain 202b to which the external resource is coupled. For example, the PMIC 218 may have the same ASIL as the main domain 202a, and the PMIC that provides power to the safety domain 202b may have the same ASIL as the safety domain 202b. The safety domain 202b may include the same or different processing resources and components as the main domain 202a as described herein with respect to the main domain 202a. For example, the safety domain 202b may include the processors 204, the system components and resources 206, the power management controller 208, the memory controller 210, the sensor controller 212, and the driver assistance controller 214. The safety domain 202b may be coupled to certain external resource(s) 226, which may be representative of a PMIC, memory, sensors, and/or driver assistance module, for example, as described herein with respect to the main domain 202a.

In addition to the SoC 200 discussed above, various aspects may be implemented in a wide variety of computing systems, which may include a single processor, multiple processors, multicore processors, or any combination thereof. Various aspects described herein may also be implemented in systems that employ more than one SoC. For example, a SoC-based ECU may include multiple SoCs (e.g., SoCs 200) configured to monitor the safety of a vehicle control system (e.g., vehicle control system 102). In these examples, each of the multiple SoC(s) may include different numbers of main domains and/or safety domains.

### Example Safety Monitoring of SoC

FIG. 3 is a block diagram of an example SoC-based ECU 300a in communication with one or more other ECUs 300b, for example, for safety monitoring. In this example, the ECU 300a and the other ECU(s) 300b may operate in a vehicle control system and/or any vehicle system or subsystem, as described herein with respect to FIG. 1. The ECU 300a may perform some vehicle control operations (e.g., infotainment, environmental, ADAS, etc.), and the other ECU(s) 300b may perform some vehicle control operations (e.g., system wide controls, engine controls, drivetrain controls, other ADAS features, etc.). As an example, the ECU 300a may be an ADAS ECU. The ECU 300a may include the SoC 200 and corresponding external resources as described herein with respect to FIG. 2. In some aspects, the other ECU(s) 300b may include a SoC-based ECU, such as the SoC 200 and corresponding external resources as described herein with respect to FIG. 2.

The main domain 202a may operate independently of the safety domain 202b with independent external resources. For example, the main domain 202a may receive power from main domain PMIC(s) 218a, and the safety domain 202b may receive power from safety domain PMIC(s) 218b, which are different from the main domain PMIC(s) 218a and may provide independent power. Such a power architecture may allow the main domain 202a to operate even while the safety domain 202b is shut down or in a low power state, or vice versa. In some cases, the safety domain 202b may be operational to monitor the main domain 202a for errors.

Any of the main domain 202a, the safety domain 202b, the main domain PMIC(s) 218a, and/or the safety domain PMIC(s) 218b may perform self-error detection, where the component may detect an error that occurs at the component. For example, the main domain 202a may detect an error that occurs at the main domain 202a. These components may also perform redundant error detection as further described herein, where the component may detect an error that occurs at another component. For example, the safety domain 202b may detect an error that occurs at the main domain 202a, or vice versa. The safety domain 202b may monitor a safety subsystem of the main domain 202a for errors. The ECU 300a may use a redundant error propagation scheme, where any errors detected within safety subsystems are routed to the main domain 202a and the safety domain 202b. For example, the safety domain PMIC(s) 218b may notify the main domain 202a of the occurrence of an error associated with the safety domain 202b or the occurrence of an error within the safety domain PMIC(s) 218b.

The main domain 202a may be in communication with the safety domain 202b, the main domain PMIC(s) 218a, and/or the safety domain PMIC(s) 218b. Any of the safety domain 202b, the main domain PMIC(s) 218a, and/or the safety domain PMIC(s) 218b may monitor for errors associated with the main domain 202a. An error associated with the main domain 202a may include an error occurring at the main domain 202a or at any of the external resources (e.g., PMIC, memory, sensors, driver assistance modules, etc.) associated with the main domain 202a. In some cases, the main domain 202a may notify the safety domain 202b, the main domain PMIC(s) 218a, and/or the safety domain PMIC(s) 218b of the occurrence of an error associated with the main domain 202a.

In certain cases, the safety domain 202b, the main domain PMIC(s) 218a, and/or the safety domain PMIC(s) 218b may detect the error associated with the main domain 202a. The safety domain 202b, the main domain PMIC(s) 218a, and/or the safety domain PMIC(s) 218b may detect if the main domain 202a has suspended operations or is unresponsive. For example, the safety domain 202b, the main domain PMIC(s) 218a, and/or the safety domain PMIC(s) 218b may detect that the main domain 202a has stopped outputting a watchdog timer or is unresponsive to a challenge in a challenge-response exchange with the main domain 202a. A watchdog timer, a heartbeat, and/or challenge-response operation may be implemented between the main domain 202a and any of the safety domain 202b, the main domain PMIC(s) 218a, and/or the safety domain PMIC(s) 218b to ensure detection of the main domain 202a getting hung, suspending an operation, or being unresponsive. As an example, the safety domain 202b may request the main domain 202a to perform a calculation and provide the safety domain 202b with the result. If the main domain 202a provides the wrong result or is unresponsive, the safety domain 202b may detect the occurrence of an error at the main domain 202a.

The safety domain 202b may be in communication with the main domain 202a, the safety domain 202b, and/or the safety domain PMIC(s) 218b. Any of the main domain 202a and the safety domain PMIC(s) 218b may monitor for errors associated with the safety domain 202b. An error associated with the safety domain 202b may include an error occurring at the safety domain 202b or at any of the external resources associated with the safety domain 202b. In some cases, the safety domain 202b may notify the main domain 202a and/or the safety domain PMIC(s) 218b of the occurrence of an error associated with the safety domain 202b (e.g., to enable the ECU 300b to take appropriate action in response). In certain cases, the main domain 202a and/or the safety domain PMIC(s) 218b may detect the error associated with the safety domain 202b, for example, based on a watchdog operation and/or challenge-response operation.

The main domain 202a and the safety domain 202b may be in communication with the other ECU(s) 300b via separate buses 330a, 330b (collectively referred to herein as “buses 330”). The buses 330 may include a wired communication link (e.g., a CAN bus, a USB connection, an Ethernet connection, etc.) and/or a wireless communication link (e.g., a Wi-Fi® link, Bluetooth® link, ZigBee® link, ANT+® link, etc.). The buses 330 may provide redundant communication paths to the other ECU(s) 300b. Error information associated with the SoC 200 may be propagated via the first bus 330a from the main domain 202a to the other ECU(s) 300b, where error information associated with the SoC 200 may include an error occurring at the main domain 202a, the safety domain 202b, or at any of the external resources associated with the main domain 202a and/or the safety domain 202b. Error information associated with the SoC 200 may be propagated via the second bus 330b from the safety domain 202b to the other ECU(s) 300b.

In some cases, the main domain 202a and/or safety domain 202b may notify the other ECU(s) 300b of the occurrence of an error associated with the main domain and/or the safety domain 202b via the buses 330. In certain cases, the other ECU(s) 300b may detect the error associated with the main domain 202a and/or the safety domain 202b via the buses 330, for example, based on a watchdog operation and/or a challenge-response operation.

The main domain PMIC(s) and/or the safety domain PMIC(s) 218b may be in communication with the other ECU(s) 300b via communication links 332a, 332b (collectively referred to herein as “communication links 332”), such as a bus or one or more input/output (I/O) interfaces (e.g., I/O pins). The safety domain PMIC(s) 218b may be in communication with the main domain PMIC(s) 218a. Power-on and/or shutdown sequencing signals may be received at the main domain PMIC(s) 218a and/or the safety domain PMIC(s) 218b from the other ECU(s) 300b. The main domain PMIC(s) 218a and/or the safety domain PMIC(s) 218b may obtain a power-on instruction and/or a shutdown instruction from the other ECU(s) 300b. In certain cases, the main domain PMIC(s) 218a and/or the safety domain PMIC(s) 218b may receive, from the other ECU(s) 300b, an indication to perform a fast shutdown, for example, due to a sudden loss of power from an external power supply. Such an indication may be routed to a dedicated control pin of the main domain PMIC(s) 218a and/or the safety domain PMIC(s) 218b. Input supply monitoring for the PMIC(s) 218a, 218b may be performed externally either through an ASIL-rated pre-regulator or some other entity (e.g., the other ECU(s) 300b). The input supply to the PMIC(s) 218a, 218b may be ensured to be within the specifications associated with the PMIC(s) 218a, 218b.

In some cases, the safety domain PMIC(s) 218b may indicate to the main domain PMIC(s) 218a to power on or shut down the main domain 202a in response to the instruction(s). The main domain PMIC(s) 218a and the safety domain PMIC(s) 218b may also power on or shut down the main domain 202a and/or the safety domain 202b in response to the instruction(s).

The safety domain PMIC(s) 218b may receive an indication of an error associated with the SoC 200 from the main domain 202a, the safety domain 202b, and/or the main domain PMIC(s) 218a. The safety domain PMIC(s) 218b may notify the other ECU(s) 300b of the occurrence of an error associated with the main domain 202a, the main domain PMIC(s) 218a, and/or the safety domain 202b via the communication link 332b. In some cases, the other ECU(s) 300b may detect the occurrence of an error associated with the main domain 202a, the main domain PMIC(s) 218a, and/or the safety domain 202b via the communication link 332b, for example, based on a watchdog operation and/or a challenge-response operation.

In response to detecting an error associated with the main domain 202a and/or the safety domain 202b, the other ECU(s) 300b may be notified of the error by any of the main domain 202a, the safety domain 202b, and/or the safety domain PMIC(s) 218b. The other ECU(s) 300b may take corrective action based on the error. For example, the other ECU(s) 300b may instruct the SoC 200 to shut down any of the main domain 202a and the safety domain 202b, and the other ECU(s) 300b may operate the vehicle without the operations performed by the ECU 300a or taking over all or some of the operations performed by the ECU 300a. In response to detecting the error, the other ECU(s) 300b may operate according to a specific safety policy, for example, designed by the original equipment manufacturer (OEM) of the vehicle. In certain aspects, when the SoC 200 is unresponsive to commands, the ECU(s) 300b may drive shutdown of the SoC 200 by sending forceful shutdown (power-off) commands to the main domain PMIC(s) 218a and/or safety domain PMIC(s) 218b.

If the SoC 200 has a functional safety error or warning, the SoC 200 may notify the safety domain PMIC(s) 218b of the error via at least one error pin (e.g., at least one pin of a general purpose IO (GPIO)) routed from the SoC 200 to the safety domain PMIC(s) 218b). The error pin(s) are capable of communicating errors very quickly, without software intervention. In certain aspects, a communication bus may be used in addition or as an alternative to the error pin(s) for more detailed functional safety error or warning information communication. In response to detecting such an error, the SoC 200 may indicate, to the main domain PMIC(s) 218a and/or the safety domain PMIC(s) 218b, to shut down the SoC 200. In response to detecting such an error, the SoC 200 may notify the other ECU(s) 300 of the functional safety error or warning associated with the SoC 200 via any of the buses 330. In certain aspects, the main domain PMIC(s) 218a and/or the safety domain PMIC(s) 218b may also inform the ECU(s) 300 of the functional safety error and the subsequent action of shutting down the SoC 200.

In some cases, if the SoC 200 has a functional safety (FuSa) error or warning, the SoC 200 may notify the main domain PMIC(s) 218a of the error via error pins routed from the SoC 200 to at least two main domain PMIC(s) 218a. As the main domain 202a may use two or more PMICs, a primary PMIC and a secondary PMIC could be used for error monitoring. ASIL decomposition may be applied to achieve highest ASIL for error reporting through the error pins from the SoC 200 to the main domain PMIC(s) 218a. The SoC 200 may request the main domain PMIC(s) 218a and the safety domain PMIC(s) 218b to shut down the SoC 200.

A FuSa error or warning may include an error that can jeopardize the safety of future operations at a component, such as the main domain 202a or the safety domain 202b. The safety systems of the SoC 200 may monitor FuSa errors and/or FuSa warnings. A FuSa error may include an electrical and/or electronic fault detected through hardware or software safety mechanisms that leads to an uncorrectable error within safety systems of the SoC 200. The detected error can lead to failure and/or violation of a particular safety goal. A FuSa warning may include an electrical and/or electronic fault detected through hardware or software safety mechanisms within the safety systems of the SoC 200. The detected faults associated with a FuSa warning may be correctable faults or uncorrectable faults. A correctable fault associated with a FuSa warning can be detected, reported, and corrected by the safety systems of the vehicle (e.g., the other ECU(s) 300b) and/or the SoC 200. For example, a correctable fault may be a memory error handled by error correction code, such as a 1-bit error. An uncorrectable fault associated with a FuSa warning may be a known fault that can be handled by a safety policy of the OEM. For example, in response to detecting an uncorrectable fault, the safety policy may dictate providing a notification of the warning, such as a SoC temperature excursion warning (e.g., triggered by an on-die temperature of the SoC exceeding a warning threshold, but not the error threshold) or a SoC voltage excursion warning (e.g., triggered by an on-die voltage of the SoC exceeding a warning threshold, but not the error threshold). In certain aspects, the FuSa error or warning may include a systematic fault associated with software or hardware, such as a software bug or hardware design bug.

For example, a functional safety error or warning may include a miscalculation or faulty determination performed at the main domain 202a and/or the safety domain 202b, corrupted or malfunctioning memory coupled to the main domain 202a and/or the safety domain 202b (e.g., due to a memory bit being flipped), or an inability for the main domain 202a and/or the safety domain 202b to communicate with a sensor and/or a control device (e.g., an actuator, relay, switch, etc.). As another example, a functional safety error may include a malfunction occurring at a sensor (e.g., corrupted data for the measurements) or a control device (e.g., a stuck actuator or non-operational relay).

The safety domain 202b may perform watchdog operations and/or challenge-response operations for the main domain 202a to detect if the main domain 202a suspends an operation or becomes hung in an operation or unresponsive. In response to detecting such an error, the safety domain 202b may notify the other ECU(s) 300b of the error associated with the main domain 202a. In some cases, the safety domain 202b may indicate, to the main domain PMIC(s) 218a, to shut down the main domain 202a, and the safety domain 202b may continue operating without the main domain 202a. The safety domain 202b may be functionally isolated from the main domain 202a to allow the safety domain 202b to operate independently of the main domain 202a. The safety domain PMIC(s) 218b and/or the other ECU(s) 300b may perform watchdog operations and/or challenge-response operations for the main domain 202a and/or the safety domain 202b to detect if the main domain 202a and/or the safety domain 202b suspends an operation or becomes hung in an operation or unresponsive.

If the main domain PMIC(s) 218a has a functional safety error or warning, the main domain PMIC(s) 218a may notify the safety domain 202b and/or the safety domain PMIC(s) 218b, for example, via at least one error pin routed from the main domain PMIC(s) 218a to the safety domain 202b,the safety domain PMIC(s) 218b, and/or the ECU(s) 300b. The communication of the functional safety error or warning from the main domain PMIC(s) 218b to the safety domain 202b, the safety domain PMIC(s) 218b, and/or the ECU(s) 300b may occur through one or more communication bus interfaces (e.g., Serial Peripheral Interface (SPI), UART, Inter-Integrated Circuit (I²C), or the like) in addition to the error pin(s), or instead of the error pin(s) (e.g., via a communication interface from the PMIC(s) 218b. In response to detecting such an error, the main domain PMIC(s) 218a may drive the shutdown of the main domain 202a. A SoC-level shutdown may be performed with the safety domain PMIC(s) 218b driving the shutdown of the safety domain 202b. In certain aspects, the safety domain 202b may continue to operate to provide a degraded mode of operation without the main domain 202a. For certain aspects, the safety domain 202b may request the safety domain PMIC(s) 218b to shut down the safety domain 202b.

If the safety domain PMIC(s) 218b has a functional safety error or warning, the safety domain PMIC(s) 218b may notify the main domain 202a via at least one error pin routed from the safety domain PMIC(s) 218b to the main domain 202a. In certain aspects, the communication of the functional safety error or waring from the safety domain PMIC(s) 218b to the main domain 202a may occur through a communication bus interface (e.g., SPI, UART, I²C, or the like) in addition or as an alternative to the error pin(s). Similarly, in certain aspects, a suitable communication interface may relay the error in the safety domain PMIC(s) 218b to the ECU(s) 300b. In response to detecting such an error, the main domain 202a may notify the other ECU(s) 300b of the error via the first bus 330a. The main domain 202a may indicate, to the main domain PMIC(s) 218a, to shut down the main domain 202a. The safety domain PMIC(s) 218b may shut down the safety domain 202b. In some cases, the main domain 202a may indicate, to the safety domain PMIC(s) 218b, to shut down the safety domain 202b.

If the main domain 202a has a functional safety error or warning, the main domain 202a may notify the safety domain PMIC(s) 218b of the error via an error pin routed from the SoC 200 to the safety domain PMIC(s) 218b. In response to detecting such an error, the safety domain PMIC(s) 218b may instruct the main domain PMIC(s) 218a to shut down the main domain 202a, and in some cases, the safety domain PMIC(s) 218b may notify the other ECU(s) 300b of the error via the communication link 332b. In response to detecting such an error, the SoC 200 may indicate to the main domain PMIC(s) 218a to shut down the main domain 202a. In response to detecting such an error, the safety domain 202b may notify the other ECU(s) 300b of the error via the second bus 330b. In some cases, the safety domain 202b may indicate, to the main domain PMIC(s) 218a, to shut down the main domain 202a, and the safety domain 202b may continue operating without the main domain 202a being operational. In certain cases, the safety domain 202b may continue operating without sending the shutdown instruction to the main domain PMIC(s) 218a.

If the safety domain 202b has a functional safety error or warning, the safety domain 202b may notify the safety domain PMIC(s) 218b via an error pin routed from the SoC 200 to the safety domain PMIC(s) 218b. In response to detecting such an error, the safety domain 202b may instruct the main domain 202a to shut down. In response to detecting such an error, the main domain 202a may notify the other ECU(s) 300b of the error associated with the safety domain 202b. The safety domain 202b may indicate, to the safety domain PMIC(s) 218b, to shut down the safety domain 202b. In some cases, the main domain 202a may not be able to continue operating without the safety domain 202b being operational.

The SoC 200 may be configured to communicate with the other ECU(s) 300b via at least one of the first bus 330a, the second bus 330b, the main domain PMIC(s) 218a, and/or the safety domain PMIC(s) 218b without a vehicle interface processor (e.g., a microcontroller unit (MCU), also referred to as a “safety MCU” or external safety monitor) coupled between the safety domain 202b (or PMIC(s) 218) and the other ECU(s) 300b. The direct communication links between the SoC 200 (and the PMIC(s) 218) and other ECU(s) 300b may reduce the complexity and cost associated with the ECU 300a. In certain aspects, the direct communication links between the SoC 200 and other ECU(s) 300b may provide redundant communication paths allowing the SoC 200 and other ECU(s) 300b to communicate with each other, for example, in cases where one or more of the buses 330 (and/or one or more of the communication links 332) cannot be used for communications, or when certain safety subsystems within the SoC 200 or the PMIC(s) 218 detect a functional safety error.

### Aspects of Safety Enhancement And Enabling Of Advanced Lower Power States in Electronic Devices of Vehicles

Aspects of the present disclosure relate to safety monitoring and power management of electronic or logic circuits (e.g., in an integrated circuit (IC) chip) in a vehicle (e.g., an electric vehicle). An electronic circuit may include electronic components such as transistors, resistors, capacitors, inductors and/or diodes connected by wires or traces through which electric current can flow.

Power gating is a technique that cuts off power supply from a power source to the electronic circuit (e.g., the electronic circuit may be electrically coupled to an actual voltage supply provided by the power source) that is not in use (e.g., when the electronic circuit may not need to be powered up to save overall power consumption). Power gating reduces/minimize both leakage power and dynamic power of the electronic circuit. For example, the electronic circuit that is not in use may be temporarily turned off to reduce the power consumption. This temporary shutdown time may be called as a low power mode or an inactive mode of the electronic circuit (e.g., a low power state / power saving state). When the electronic circuit may be required for operation once again, the electronic circuit is activated to an active mode (e.g., a normal power state). In some aspects, there may be more steps it may take for the electronic circuit to exit a power gating state, as the electronic circuit may require voltage rails ramped, clock relocked, and many other steps involved. The power gating technique may provide the most power reduction at a cost of potentially taking longer to resume back the electronic circuit to the active mode.

Clock gating is a power management technique used in the electronic circuit for reducing dynamic power dissipation, by removing a clock signal when the electronic circuit, or a subpart of the electronic circuit, is not in use or ignores the clock signal. The electronic circuit may remain powered during clock gating with states maintained. This may allow the electronic circuit an ability to resume to the active mode in much shorter time than a power gated condition. In this case, the power saving may not be as optimal as the electronic circuit may still be powered and consumes leakage power, but the clock gating has an advantage of a lower latency for the electronic circuit to resume back to the active state for better performance. For example, the clock gating may save power by selectively disabling clock signals to unused circuitry of the electronic circuit.

A gating circuit (e.g., in a clock controller) may be used to selectively enable or disable the clock signal to a particular component or block of the electronic circuit. The gating circuit may be controlled by a signal that indicates whether the component of the electronic circuit is being used or not. When the component of the electronic circuit is not being used, the gating circuit disables the clock signal to the component of the electronic circuit. Accordingly, flip-flops associated with the component of the electronic circuit do not switch state. Since switching the state consumes power and when the flip-flops are not being switched, the switching power consumption goes to zero. This reduces overall power consumption of the electronic circuit by reducing the switching activity of the flip-flops of the electronic circuit.

In some vehicles including the electronic circuits, only clock gating may be enabled. This may limit an ability of the vehicle to take advantage of a wide range of idle conditions to reduce the power consumption of the electronic circuits of the vehicle (e.g., which may be achieved by enabling other power consumption methods as well other than the clock gating).

A present-day computer processing unit (CPU) / processing element in the electronic circuit of the vehicle may enable or facilitate more advanced and extended lower power modes or states of the electronic circuit (e.g., than prior processing elements in the vehicle). For example, the present-day processing element in the vehicle may enable processing core/processing element cluster-level clock gating (or clock gated states) as well as processing core/processing element cluster-level power gating (or power gated states) while the prior processing element in the vehicle may only enable clock gating. The extended lower power states (e.g., due to the power gating and the clock gating) of the electronic circuit of the vehicle may enable users of the vehicle better flexibility to reduce the power consumption at low and idle conditions of the vehicle, which in turn may enable the vehicle longer use time before a next charge of the vehicle is required.

In order to maintain safety compliance in the vehicle during the extended lower power states of the electronic circuit of the vehicle, techniques proposed herein may update functions of the processing element of the vehicle to add various handshake and safety provisions accompanying the extended lower power states of the electronic circuit of the vehicle.

For example, the electronic circuit of the vehicle may include or be coupled to a low power state watchdog timer, which may be configured to monitor hardware sequences of low power state transitions (e.g., turning on or off power to the electronic circuit of the vehicle) and generate alert signals (e.g., if needed based on the monitoring) that can be monitored by an error aggregation and safety island (SAIL) device. In another example, the electronic circuit of the vehicle may include or be coupled to a safety monitoring device or system, which may be configured to monitor states of multiple different signals (e.g., clock signals, power switch control signals against expectations) to enable a power gating switch control logic to work properly and alert the SAIL device as needed.

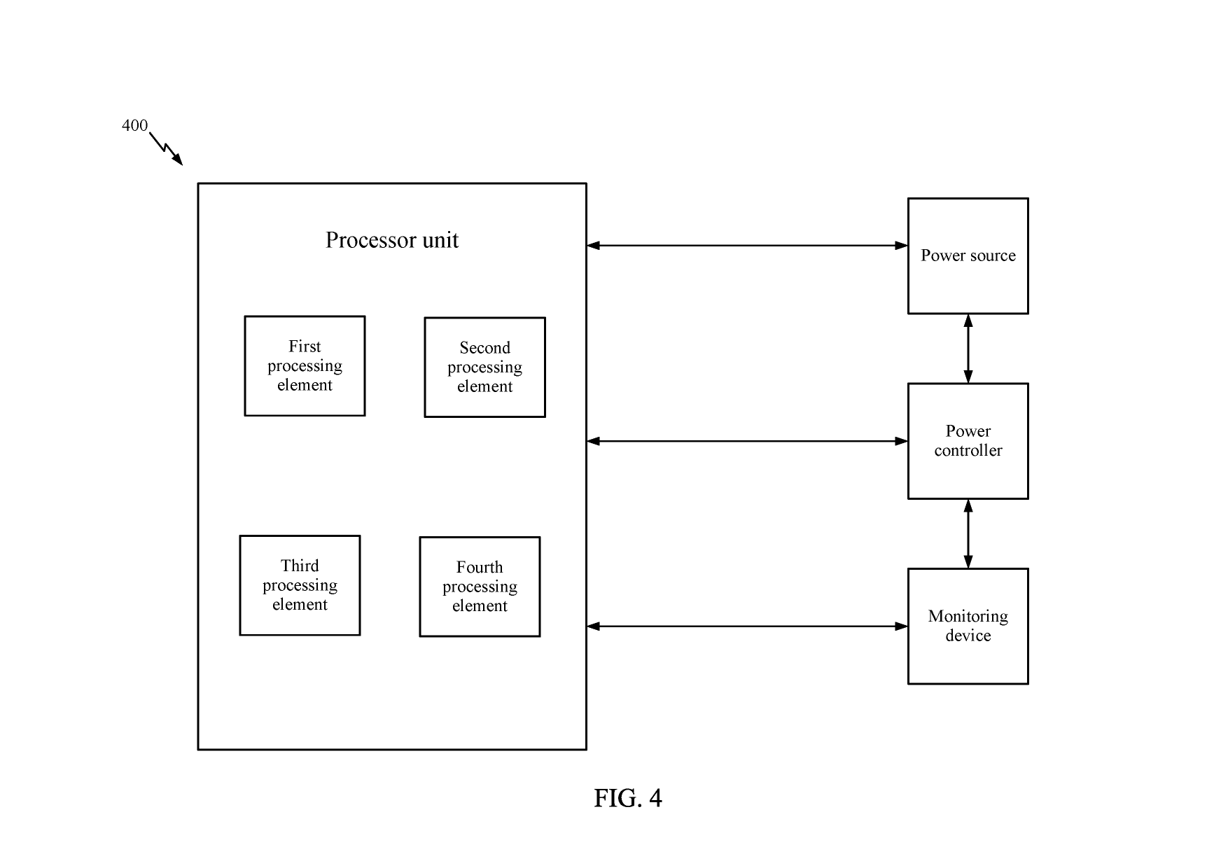

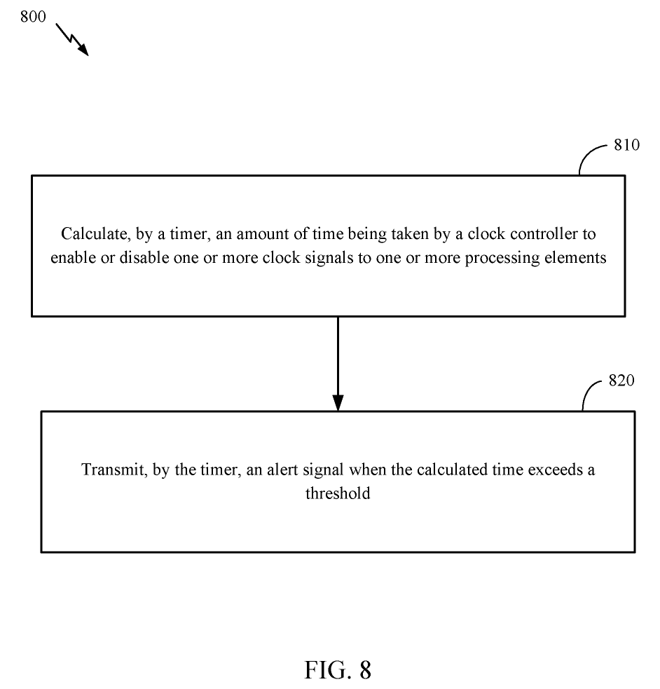

The techniques proposed herein may enable the users of the vehicle to use the expanded and extended lower power states for the electronic circuit of the vehicle (e.g., similar to mobile and computer devices where there were no safety requirements for the lower power states of the mobile and computer devices) while not compromising safety requirements of the vehicle. The techniques proposed herein may be further understood with reference to FIG. 4 - FIG. 8.

FIG. 4 is a block diagram 400 of an example safety monitoring system that may include devices configured for monitoring signals during a power saving state and a normal power state of one or more processing elements, in accordance with certain aspects of the present disclosure. In one aspect, the safety monitoring system may be included in the vehicle 100 of FIG. 1. In another aspect, the safety monitoring system may perform some functions of the vehicle control system 102 of the vehicle 100 described in FIG. 1. In another aspect, the safety monitoring system may correspond to or is associated with the SoC-based ECU 300a in FIG. 3.

The safety monitoring system may include a processor unit (e.g., in a SoC such as the SoC 200 of FIG. 2), a power source, a power controller (e.g., such as the power control system 110 of FIG. 1), and a monitoring device (e.g., such as the safety domain 202b of FIG. 2). The processor unit, the power source, the power controller, and/or the monitoring device may be coupled (e.g., electrically coupled) to each other.

The processor unit may include one or more processing elements. The processing elements may include a first processing element, a second processing element, a third processing element, and a fourth processing element. The processing elements may include or correspond to a central processing unit (CPU) 204a, signal processor(s) 204b (e.g., a digital signal processor, an image signal processor, a neural network signal processor, etc.), and/or an application processor 204c of FIG. 2.

Each processing element may include one or more processing cores. Each processing element/processing core may perform operations independent of other processing elements/processing cores. Each processing core may correspond to a single processing module that can execute instructions. The more processing cores the processing element has, the more tasks the processing element may handle simultaneously.

The power source may be coupled to the one or more processing elements. The power source may supply power to the one or more processing elements.

The power source and the one or more processing elements may be coupled to one or more power switches. For example, the one or more power switches may be coupled to and positioned between the one or more processing elements and the power source. A power switch may be turned off to cut off the power from the power supply to the one or more processing elements during a power saving state of the one or more processing elements. The power switch may be turned on to turn on the power from the power supply to the one or more processing elements during a normal power state of the one or more processing elements. In one example, the power switch may be implemented as a p-type metal-oxide-semiconductor (PMOS) transistor. In another example, the power switch may be implemented as a n-channel metal-oxide semiconductor (NMOS) transistor.

The one or more power switches may be head switches and/or tail switches. A head switch may refer to a power switch coupled between the one or more processing elements to be powered and a positive voltage rail (e.g., a positive power supply node). A tail switch may refer to a power switch coupled between the one or more processing elements and a reference potential node (e.g., electrical ground) or a negative voltage rail (e.g., a negative power supply node).

The power controller may be coupled to the one or more processing elements and/or the power source. The power controller may manage or control the supply of the power from the power source to the one or more processing elements (e.g., via the one or more power switches). For example, the power controller may be configured to turn off the power to the one or more processing elements from the power source during the power saving state of the one or more processing elements. The power controller may be configured to turn on the power to the one or more processing elements from the power source during the normal power state of the one or more processing elements.

The power controller may be configured to receive one or more power control signals (e.g., from the vehicle control system 102 of FIG. 1). The power controller may process the received power control signals. Based on the processing of the power control signals, the power controller may determine to generate and transmit one or more power switch control signals to the one or more power switches (e.g., which may be located between the one or more processing elements and the power source) to manage or control supply of the power to the one or more processing elements from the power source. In one example, the power controller may transmit the one or more power switch control signals to the one or more power switches to turn on the power to the one or more processing elements from the power source (e.g., via the one or more power switches which may be turned on or enabled). In another example, the power controller may transmit the one or more power switch control signals to the one or more power switches to turn off the power to the one or more processing elements from the power source (e.g., by turning off or disabling the one or more power switches).

The power controller may include logic for controlling the power switches. The logic may include a controller module configured to manage or control enabling or disabling of the power switches. The logic may include a logical not-OR (NOR) gate. In some aspects, the logic may control the power switches through a level shifter. In some aspects, the logic may receive an input combination, in response to which, the logic may output a logic high to open the power switches and activate the power saving state. In certain aspects, the logic may operate from a voltage rail.

The monitoring device may be coupled to the one or more processing elements, the power source, and/or the power controller. The monitoring device may include a controller module, which may be configured to monitor operations of the power controller and/or the one or more processing elements (e.g., to check or verify a status of the power saving state and/or the normal power state of the one or more processing elements). For example, the monitoring device may determine whether the power has been completely turned off to the one or more processing elements from the power source during the power saving state. The monitoring device may also determine whether the power has been completely turned on to the one or more processing elements from the power source during the normal power state.

The monitoring device may determine that the power has not been completely turned off (i.e., power is turned on) to the one or more processing elements from the power source during the power saving state. For example, the monitoring device may determine that the power has been turned on to the one or more processing elements from the power source during the power saving state based on some of the power switches being switched on during the power saving state. The monitoring device may then generate and transmit an alert signal (e.g., to the vehicle control system 102 of FIG. 1) when the power has not been completely turned off to the one or more processing elements from the power source during the power saving state. The alert signal may include information associated with the power switches that are switched on during the power saving state.

The monitoring device may determine that the power has not been completely turned on (i.e., power is turned off) to the one or more processing elements from the power source during the normal power state. For example, the monitoring device may determine that the power has been turned off to the one or more processing elements from the power source during the normal power state based on some of the power switches being switched off during the normal power state. The monitoring device may then generate and transmit an alert signal (e.g., to the vehicle control system 102 of FIG. 1) when the power has not been completely turned on to the one or more processing elements from the power source during the normal power state. The alert signal may include information associated with some of the power switches that are switched off during the normal power state.

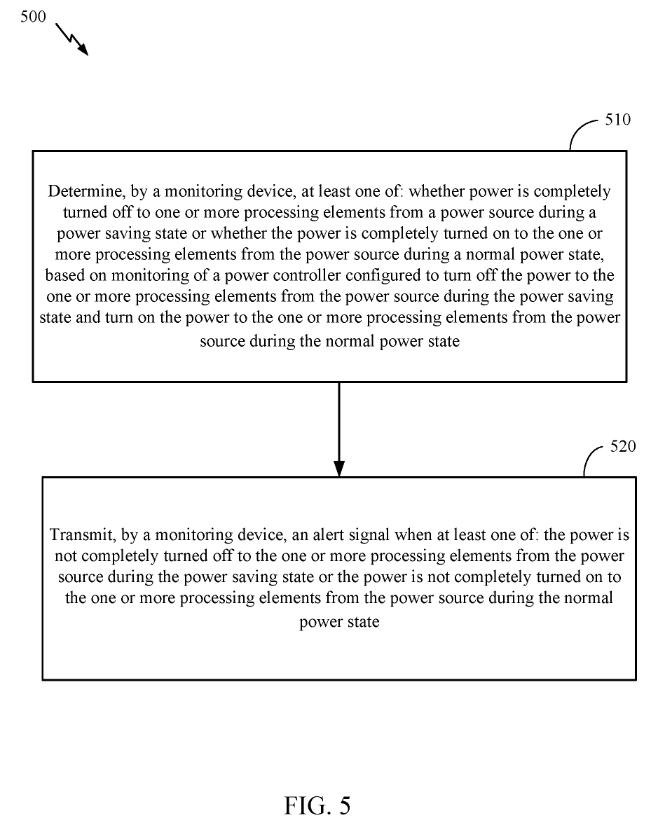

FIG. 5 is a flow diagram depicting example method or operations 500 performed at a monitoring device for monitoring signals during a power saving state and a normal power state of one or more processing elements, in accordance with certain aspects of the present disclosure. The method 500 may be performed by the monitoring device, as described herein with respect to FIG. 4.

Method 500 begins at 510 with determining at least one of: whether power is completely turned off to the one or more processing elements from a power source during the power saving state or whether the power is completely turned on to the one or more processing elements from the power source during the normal power state, based on monitoring of a power controller configured to turn off the power to the one or more processing elements from the power source during the power saving state and turn on the power to the one or more processing elements from the power source during the normal power state

Method 500 then proceeds to 520 with transmitting an alert signal when at least one of: the power is not completely turned off to the one or more processing elements from the power source during the power saving state or the power is not completely turned on to the one or more processing elements from the power source during the normal power state

In certain aspects, each processing element may include multiple processor cores.

In certain aspects, the power controller may be configured to receive two or more power control signals. The power controller may be further configured to determine, based on the two or more power control signals, transmission of one or more power switch control signals to one or more power switches between the one or more processing elements and the power source to turn on or turn off the power to the one or more processing elements from the power source.

In certain aspects, the method 500 further includes determining that the power is turned on to the one or more processing elements from the power source during the power saving state when at least one of the one or more power switches is switched on during the power saving state.

In certain aspects, the alert signal carries information associated with the at least one of the one or more power switches that is switched on during the power saving state.

In certain aspects, the method 500 further includes determining that the power is turned off to the one or more processing elements from the power source during the normal power state when at least one of the one or more power switches is switched off during the normal power state.

In certain aspects, the alert signal carries information associated with the at least one of the one or more power switches that is switched off during the normal power state.

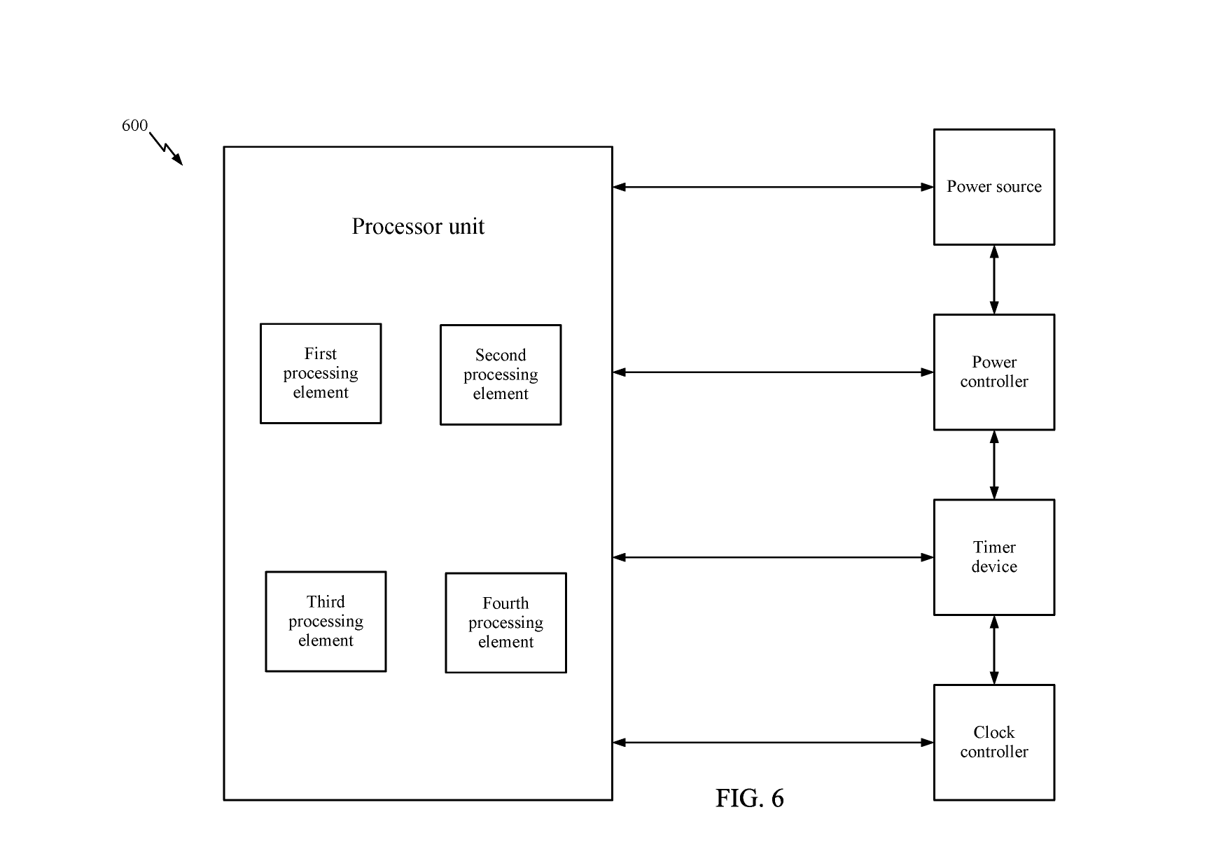

FIG. 6 is a block diagram 600 of an example safety monitoring system that may include devices configured for monitoring operations of a power controller and a clock controller, in accordance with certain aspects of the present disclosure. In one aspect, the safety monitoring system may be included in the vehicle 100 of FIG. 1. In another aspect, the safety monitoring system may perform some functions of the vehicle control system 102 of the vehicle 100 described in FIG. 1. In another aspect, the safety monitoring system may correspond to or is associated with the SoC-based ECU 300a in FIG. 3.

The safety monitoring system may include a processor unit (e.g., in a SoC such as the SoC 200 of FIG. 2), a power source, a power controller (e.g., such as the power control system 110 of FIG. 1), a timer device, and a clock controller. The processor unit, the power source, the power controller, the timer device, and/or the clock controller may be coupled (e.g., electrically coupled) to each other.

As noted above, the processor unit may include one or more processing elements. Each processing element may include one or more processing cores. Each processing element/processing core may perform operations independent of other processing elements/processing cores. Each processing core may correspond to a single processing module that can execute instructions.

The power source may be coupled to the one or more processing elements and supply power to the one or more processing elements. The power source and the one or more processing elements may be coupled to one or more power switches. A power switch may be turned off to cut off the power from the power supply to the one or more processing elements during a power saving state of the one or more processing elements. The power switch may be turned on to turn on the power from the power supply to the one or more processing elements during a normal power state of the one or more processing elements.

The power controller may be coupled to the one or more processing elements and/or the power source. The power controller may manage or control the power from the power source to the one or more processing elements. For example, the power controller may be configured to turn off the power to the one or more processing elements from the power source during the power saving state of the one or more processing elements. The power controller may be configured to turn on the power to the one or more processing elements from the power source during the normal power state of the one or more processing elements.

The timer device may be coupled to the one or more processing elements, the power source, and/or the power controller. The timer device may include a controller module, which may be configured to monitor operations of the power controller.

In one aspect, the timer device may calculate an amount of time being taken by the power controller to turn on the power to the one or more processing elements from the power source. For example, the timer device may calculate the amount of time taken by the power controller to switch on the power switches (e.g., coupled between the one or more processing elements and the power source) to turn on the power to the one or more processing elements from the power source via the power switches.

In another aspect, the timer device may calculate an amount of time being taken by the power controller to turn off the power to the one or more processing elements from the power source. For example, the timer device may calculate the amount of time taken by the power controller to switch off the power switches to turn off the power to the one or more processing elements from the power source via the power switches.

The timer device may generate and transmit an alert signal (e.g., to the vehicle control system 102 of FIG. 1) when the calculated time exceeds a threshold.

In one aspect, the timer device may transmit the alert signal when the time taken by the power controller to turn on the power to the one or more processing elements from the power source may exceed a first threshold. The first threshold may indicate a maximally allowed amount of time that can be taken by the power controller to turn on the power to the one or more processing elements from the power source.

In another aspect, the timer device may transmit the alert signal when the time taken by the power controller to turn off the power to the one or more processing elements from the power source exceeds a second threshold. The second threshold may indicate a maximally allowed amount of time that can be taken by the power controller to turn off the power to the one or more processing elements from the power source.

The alert signal may include information associated with an operational status of the power switches between the one or more processing elements and the power source. For example, the operational status may indicate which power switches are turned on and/or turned off. In some aspects, the alert signal may trigger an error detection circuit (e.g., which may be coupled to the timer device and/or is part of the vehicle control system 102 of FIG. 1) to detect the operational status of the power switches between the one or more processing elements and the power source.

The clock controller may be coupled to the one or more processing elements, the power source, the power controller, and/or the timer device. The clock controller may be configured to manage or control transmission of one or more clock signals to the one or more processing elements. A clock signal may be an electronic logic signal (e.g., voltage or current), which oscillates between a high and a low state at a constant frequency.

In one aspect, the clock controller may enable or activate transmission of the one or more clock signals to the one or more processing elements. For example, the clock controller may receive an input to enable transmission of the one or more clock signals to the one or more processing elements. In response to the received input, the clock controller may enable or activate transmission of the one or more clock signals to the one or more processing elements.

In another aspect, the clock controller may disable transmission of the one or more clock signals to the one or more processing elements. For example, the clock controller may receive an input to disable transmission of the one or more clock signals to the one or more processing elements. In response to the received input, the clock controller may disable or deactivate transmission of the one or more clock signals to the one or more processing elements.

The timer device may be configured to monitor operations of the clock controller.

In one aspect, the timer device may calculate an amount of time being taken by the clock controller to enable transmission of the one or more clock signals to the one or more processing elements. For example, the timer device may calculate the amount of time taken by the clock controller to enable transmission of the one or more clock signals to the one or more processing elements upon receiving an input to enable transmission of the clock signals.

In another aspect, the timer device may calculate an amount of time being taken by the clock controller to disable transmission of the one or more clock signals to the one or more processing elements. For example, the timer device may calculate the amount of time taken by the power controller to disable transmission of the one or more clock signals to the one or more processing elements upon receiving an input to disable transmission of the clock signals.

The timer device may generate and transmit an alert signal (e.g., to the vehicle control system 102 of FIG. 1) when the calculated time exceeds a threshold.

In one aspect, the timer device may transmit the alert signal when the time taken by the clock controller to enable transmission of the one or more clock signals to the one or more processing elements may exceed a first threshold. The first threshold may indicate a maximally allowed amount of time that can be taken by the clock controller to enable transmission of the one or more clock signals to the one or more processing elements.

In another aspect, the timer device may transmit the alert signal when the time taken by the clock controller to disable transmission of the one or more clock signals to the one or more processing elements exceeds a second threshold. The second threshold may indicate a maximally allowed amount of time that can be taken by the clock controller to disable transmission of the one or more clock signals to the one or more processing elements.

The alert signal may include information associated with an operational status of the one or more clock signals. The operational status may indicate disabled or enabled clock signals. The alert signal may trigger an error detection circuit (e.g., which may be coupled to the timer device and/or is part of the vehicle control system 102 of FIG. 1) to detect the operational status of the one or more clock signals.

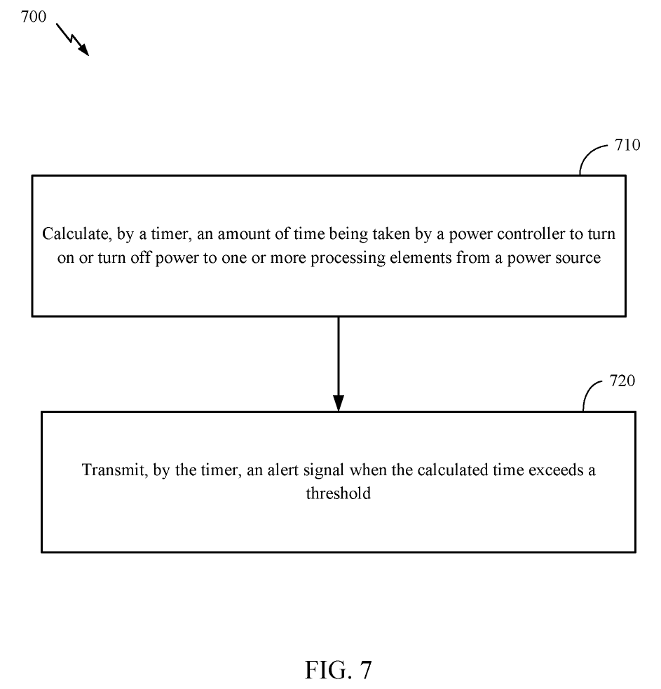

FIG. 7 is a flow diagram depicting example method or operations 700 performed at a timer for determining an amount of time being taken by a power controller to turn on or turn off power to one or more processing elements from a power source, in accordance with certain aspects of the present disclosure. The operations 700 may be performed by the timer device, as described herein with respect to FIG. 6.

Method 700 begins at 710 with calculating the amount of time being taken by the power controller to turn on or turn off the power to the one or more processing elements from the power source. For example, the power controller may be configured to turn on or turn off the power to the one or more processing elements from the power source.

Method 700 then proceeds to 720 with transmitting an alert signal when the calculated time exceeds a threshold.

In certain aspects, the power controller may be configured to receive two or more power control signals, and then determine, based on the two or more power control signals, transmission of one or more power switch control signals to one or more power switches between the one or more processing elements and the power source to turn on or turn off the power to the one or more processing elements from the power source.

In certain aspects, the threshold indicates a maximally allowed amount of time that can be taken by the power controller to turn on or turn off the power to the one or more processing elements from the power source.

In certain aspects, the alert signal carries information associated with an operational status of one or more power switches between the one or more processing elements and the power source.

In certain aspects, the alert signal triggers an error detection circuit to detect an operational status of one or more power switches between the one or more processing elements and the power source.

FIG. 8 is a flow diagram depicting example method or operations 800 performed at a timer for determining an amount of time being taken by a clock controller to enable or disable one or more clock signals to one or more processing elements, in accordance with certain aspects of the present disclosure. The operations 800 may be performed by the timer device, as described herein with respect to FIG. 6.

Method 800 begins at 810 with calculating the amount of time being taken by the clock controller to enable or disable the one or more clock signals to the one or more processing elements. For example, the clock controller may be configured to enable or disable the one or more clock signals to the one or more processing elements.

Method 800 then proceeds to 820 with transmitting an alert signal when the calculated time exceeds a threshold.

In certain aspects, each processing element may include multiple processor cores.

In certain aspects, the clock controller may be configured to receive an input to enable or disable the one or more clock signals to the one or more processing elements, and enable or disable the one or more clock signals to the one or more processing elements in response to the received input.

In certain aspects, the threshold indicates a maximally allowed amount of time that can be taken by the clock controller to enable or disable the one or more clock signals to the one or more processing elements.

In certain aspects, the alert signal carries information associated with an operational status of the one or more clock signals.

In certain aspects, the alert signal triggers an error detection circuit to detect an operational status of the one or more clock signals.

The various operations of methods described above may be performed by any suitable means capable of performing the corresponding functions. The means may include various hardware and/or software component(s) and/or module(s), including, but not limited to a circuit, an application specific integrated circuit (ASIC) or a processor.

### Example Clauses

Implementation examples are described in the following numbered clauses:

Clause 1: A method at a monitoring device, comprising: determining at least one of: whether power is completely turned off to one or more processing elements from a power source during a power saving state or whether the power is completely turned on to the one or more processing elements from the power source during a normal power state based on monitoring of a power controller configured to turn off the power to the one or more processing elements from the power source during the power saving state and turn on the power to the one or more processing elements from the power source during the normal power state; and transmitting an alert signal when at least one of: the power is not completely turned off to the one or more processing elements from the power source during the power saving state or the power is not completely turned on to the one or more processing elements from the power source during the normal power state.

Clause 2: The method of clause 1, wherein each processing element comprises multiple processor cores.

Clause 3: The method of any one of clauses 1-2, wherein the power controller is configured to: receive two or more power control signals; and determine, based on the two or more power control signals, transmission of one or more power switch control signals to one or more power switches between the one or more processing elements and the power source to turn on or turn off the power to the one or more processing elements from the power source.

Clause 4: The method of clause 3, further comprising determining that the power is turned on to the one or more processing elements from the power source during the power saving state when at least one of the one or more power switches is switched on during the power saving state.

Clause 5: The method of clause 4, wherein the alert signal carries information associated with the at least one of the one or more power switches that is switched on during the power saving state.

Clause 6: The method of clause 3, further comprising determining that the power is turned off to the one or more processing elements from the power source during the normal power state when at least one of the one or more power switches is switched off during the normal power state.

Clause 7: The method of clause 6, wherein the alert signal carries information associated with the at least one of the one or more power switches that is switched off during the normal power state.

Clause 8: A method at a timer, comprising: calculating an amount of time being taken by a power controller to turn on or turn off power to one or more processing elements from a power source; and transmitting an alert signal when the calculated time exceeds a threshold.

Clause 9: The method of clause 8, wherein each processing element comprises multiple processor cores.

Clause 10: The method of any one of clauses 8-9, wherein the power controller is configured to: receive two or more power control signals; and determine, based on the two or more power control signals, transmission of one or more power switch control signals to one or more power switches between the one or more processing elements and the power source to turn on or turn off the power to the one or more processing elements from the power source.

Clause 11: The method of any one of clauses 8-10, wherein the threshold indicates a maximally allowed amount of time that can be taken by the power controller to turn on or turn off the power to the one or more processing elements from the power source.

Clause 12: The method of any one of clauses 8-11, wherein the alert signal carries information associated with an operational status of one or more power switches between the one or more processing elements and the power source.

Clause 13: The method of any one of clauses 8-12, wherein the alert signal triggers an error detection circuit to detect an operational status of one or more power switches between the one or more processing elements and the power source.

Clause 14: A method at a timer, comprising: calculating an amount of time being taken by a clock controller to enable or disable one or more clock signals to one or more processing elements; and transmitting an alert signal when the calculated time exceeds a threshold.

Clause 15: The method of clause 14, wherein each processing element comprises multiple processor cores.

Clause 16: The method of any one of clauses 14-15, wherein the clock controller is configured to: receive an input to enable or disable the one or more clock signals to the one or more processing elements; and in response to the received input, enable or disable the one or more clock signals to the one or more processing elements.

Clause 17: The method of any one of clauses 14-16, wherein the threshold indicates a maximally allowed amount of time that can be taken by the clock controller to enable or disable the one or more clock signals to the one or more processing elements.

Clause 18: The method of any one of clauses 14-17, wherein the alert signal carries information associated with an operational status of the one or more clock signals.

Clause 19: The method of any one of clauses 14-18, wherein the alert signal triggers an error detection circuit to detect an operational status of the one or more clock signals.

Clause 20: An apparatus, comprising: at least one memory comprising instructions; and one or more processors configured, individually or in any combination, to execute the instructions and cause the apparatus to perform a method in accordance with any one of Clauses 1-19.

Clause 21: An apparatus, comprising means for performing a method in accordance with any one of Clauses 1-19.

Clause 22: A non-transitory computer-readable medium comprising executable instructions that, when executed by one or more processors of an apparatus, cause the apparatus to perform a method in accordance with any one of Clauses 1-19.

Clause 23: A computer program product embodied on a computer-readable storage medium comprising code for performing a method in accordance with any one of Clauses 1-19.

### Additional Considerations

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage, or mode of operation. The term “coupled” is used herein to refer to the direct or indirect coupling between two objects. For example, if object A physically touches object B and object B touches object C, then objects A and C may still be considered coupled to one another—even if objects A and C do not directly physically touch each other. For instance, a first object may be coupled to a second object even though the first object is never directly physically in contact with the second object. The terms “circuit” and “circuitry” are used broadly and intended to include both hardware implementations of electrical devices and conductors that, when connected and configured, enable the performance of the functions described in the present disclosure, without limitation as to the type of electronic circuits.

The apparatus and methods described in the detailed description are illustrated in the accompanying drawings by various blocks, modules, components, circuits, steps, processes, algorithms, etc. (collectively referred to as “elements”). These elements may be implemented using hardware, for example.

One or more of the components, steps, features, and/or functions illustrated herein may be rearranged and/or combined into a single component, step, feature, or function or embodied in several components, steps, or functions. Additional elements, components, steps, and/or functions may also be added without departing from features disclosed herein. The apparatus, devices, and/or components illustrated herein may be configured to perform one or more of the methods, features, or steps described herein.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover at least: a, b, c, a-b, a-c, b-c,and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c). All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for.”

It is to be understood that the claims are not limited to the precise configuration and components illustrated above. Various modifications, changes, and variations may be made in the arrangement, operation, and details of the methods and apparatus described above without departing from the scope of the claims.

1. An apparatus, comprising:
a power controller configured to turn off power to one or more processing elements from a power source during a power saving state and turn on power to the one or more processing elements from the power source during a normal power state; and
a monitoring device configured to:
determine at least one of: whether the power is completely turned off to the one or more processing elements from the power source during the power saving state or whether the power is completely turned on to the one or more processing elements from the power source during the normal power state based on monitoring of the power controller; and
transmit an alert signal when at least one of: the power is not completely turned off to the one or more processing elements from the power source during the power saving state or the power is not completely turned on to the one or more processing elements from the power source during the normal power state.

2. The apparatus of claim 1, wherein each processing element comprises multiple processor cores.

3. The apparatus of claim 1, wherein the power controller is configured to:
receive two or more power control signals; and
determine, based on the two or more power control signals, transmission of one or more power switch control signals to one or more power switches between the one or more processing elements and the power source to turn on or turn off the power to the one or more processing elements from the power source.

4. The apparatus of claim 3, wherein the monitoring device is configured to determine that the power is turned on to the one or more processing elements from the power source during the power saving state when at least one of the one or more power switches is switched on during the power saving state.

5. The apparatus of claim 4, wherein the alert signal carries information associated with the at least one of the one or more power switches that is switched on during the power saving state.

6. The apparatus of claim 3, wherein the monitoring device is configured to determine that the power is turned off to the one or more processing elements from the power source during the normal power state when at least one of the one or more power switches is switched off during the normal power state.

7. The apparatus of claim 6, wherein the alert signal carries information associated with the at least one of the one or more power switches that is switched off during the normal power state.

8. An apparatus, comprising:
a power controller configured to turn on or turn off power to one or more processing elements from a power source; and
a timer configured to:
calculate an amount of time being taken by the power controller to turn on or turn off the power to the one or more processing elements from the power source; and
transmit an alert signal when the calculated time exceeds a threshold.

9. The apparatus of claim 8, wherein each processing element comprises multiple processor cores.

10. The apparatus of claim 8, wherein the power controller is configured to:
receive two or more power control signals; and
determine, based on the two or more power control signals, transmission of one or more power switch control signals to one or more power switches between the one or more processing elements and the power source to turn on or turn off the power to the one or more processing elements from the power source.

11. The apparatus of claim 8, wherein the threshold indicates a maximally allowed amount of time that can be taken by the power controller to turn on or turn off the power to the one or more processing elements from the power source.

12. The apparatus of claim 8, wherein the alert signal carries information associated with an operational status of one or more power switches between the one or more processing elements and the power source.

13. The apparatus of claim 8, wherein the alert signal triggers an error detection circuit to detect an operational status of one or more power switches between the one or more processing elements and the power source.

14. An apparatus, comprising:
a clock controller configured to enable or disable one or more clock signals to one or more processing elements; and
a timer configured to:
calculate an amount of time being taken by the clock controller to enable or disable the one or more clock signals to the one or more processing elements; and
transmit an alert signal when the calculated time exceeds a threshold.

15. The apparatus of claim 14, wherein each processing element comprises multiple processor cores.

16. The apparatus of claim 14, wherein the clock controller is configured to:
receive an input to enable or disable the one or more clock signals to the one or more processing elements; and
in response to the received input, enable or disable the one or more clock signals to the one or more processing elements.

17. The apparatus of claim 14, wherein the threshold indicates a maximally allowed amount of time that can be taken by the clock controller to enable the one or more clock signals to the one or more processing elements.

18. The apparatus of claim 14, wherein the threshold indicates a maximally allowed amount of time that can be taken by the clock controller to disable the one or more clock signals to the one or more processing elements.

19. The apparatus of claim 14, wherein the alert signal carries information associated with an operational status of the one or more clock signals.

20. The apparatus of claim 14, wherein the alert signal triggers an error detection circuit to detect an operational status of the one or more clock signals.
